(19) United States
(12) Patent Application Publication
(10) Pub. No.: US 2011/0083797 A1
(43) Pub. Date: Apr. 14, 2011

(54) METHOD OF FORMING A FLEXIBLE DISPLAY PANEL AND ALIGNMENT LAYER AND SPACER THEREOF

(76) Inventors: Chi-Yuan Huang, Taipei County (TW); Keng-Yu Tsao, Taipei City (TW); Jui-Shu Chou, Taipei City (TW); Ching-Shan Tsai, Kaohsiung City (TW); Chi-Neng Mo, Taoyuan County (TW); Mei-Tsao Chiang, Taoyuan County (TW)

(21) Appl. No.: 12/611,914

(22) Filed: Nov. 3, 2009

(30) Foreign Application Priority Data
Oct. 12, 2009 (TW) 098134493

(51) Int. Cl. B32B 37/16; B29C 59/02

(52) U.S. Cl. 156/242; 264/293

(57) ABSTRACT

A method of forming a flexible display panel and an alignment layer and spacers thereof includes the following steps. A base material is provided. A shaping process is then performed on the base material to render the base material into a structural layer including an alignment layer monolithically formed with a plurality of spacers. Subsequently, a first transparent conductive film and a second transparent conductive film are provided, and the structural layer is mounted between the first transparent conductive film and the second transparent conductive film such that the first transparent conductive film, the structural layer and the second transparent conductive film form a sandwich structure.

### BACKGROUND OF THE INVENTION

1. Field of the Invention

The present invention relates to a method of forming a flexible display panel and an alignment layer and spacers, and more particularly, to a method of using a shaping process to form an alignment layer monolithically formed with a plurality of spacers and a method of using a two-plate technique of the flexible circuit board to form a flexible display panel.

2. Description of the Prior Art

Flexible display panels, with paper-like properties such as being thin, flexible and easy to carry, are applied in products such as electronic paper, a smart card, or an E-price tag. In the conventional flexible display panel, bead spacers are usually used to maintain the cell gap of the flexible display panel. However, since the flexible display panel is flexible, the bead spacers are easily worn away by rubbing with the display panel in the process of bending the display panel. Accordingly, the conventional flexible display panels are not durable.

As a result, in the development of the flexible display panel, spacers with a moderate degree of hardness and better abrasion resistance are needed to effectively maintain the cell gap of the flexible display panel and to improve the durability of the flexible display panel.

### SUMMARY OF THE INVENTION

It is therefore one objective of the present invention to provide a method of forming a flexible display panel and an alignment layer and spacers to improve the abrasion resistance of the spacers and the durability of the flexible display panel.

According to the present invention, a method of forming an alignment layer and spacers is provided. The method includes the following steps. First, a base material is provided. Then, a shaping process is then performed on the base material to render the base material into a structural layer including an alignment layer monolithically formed with a plurality of spacers.

According to the present invention, a method of forming a flexible display panel is provided. The method includes the following steps. First, a base material is provided. Then, a shaping process is then performed on the base material to render the base material into a structural layer including an alignment layer monolithically formed with a plurality of spacers. Subsequently, a first transparent conductive film and a second transparent conductive film are provided, and the structural layer is mounted between the first transparent conductive film and the second transparent conductive film such that the first transparent conductive film, the structural layer and the second transparent conductive film form a sandwich structure.

The present invention uses all kinds of shaping techniques to directly form the alignment layer monolithically formed with a plurality of spacers to improve the degree of hardness and the abrasion resistance of the spacers. In addition, the present invention uses the two-plate technique of the flexible circuit board to form the flexible display panel to improve the durability and the flexibility of the flexible display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are schematic diagrams illustrating a method of forming an alignment layer and spacers according to a preferred embodiment of the present invention.

FIGS. 4-5 are schematic diagrams illustrating a method of forming a flexible display panel according to a preferred embodiment of the present invention.

### DETAILED DESCRIPTION

In the following specifications and claims, certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to”.

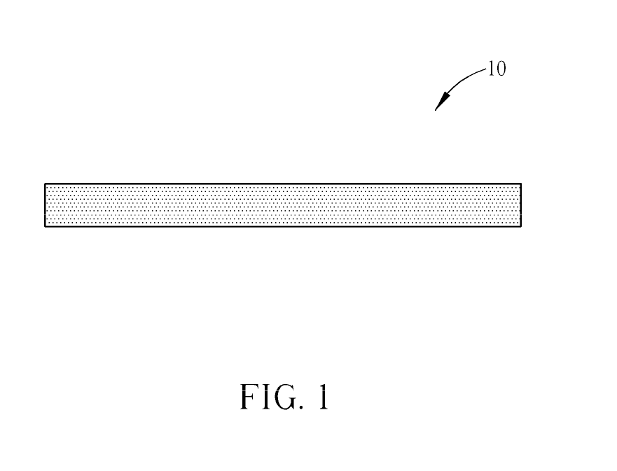

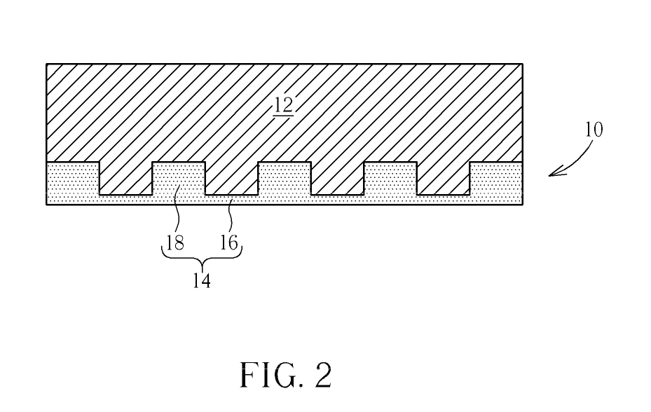

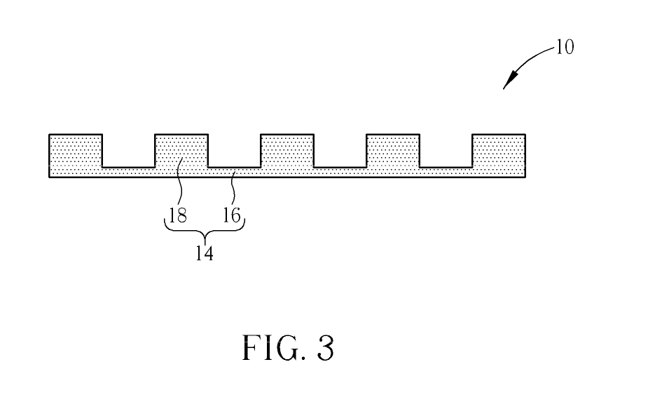

Please refer to FIGS. 1-3. FIGS. 1-3 are schematic diagrams illustrating a method of forming an alignment layer and spacers according to a preferred embodiment of the present invention. As shown in FIG. 1, a base material 10 is first provided. The base material 10 may include a plastic material such as a thermoplastic material or a thermosetting material, but the base material 10 is not limited herein and may be another suitable material. As shown in FIG. 2, a prefabricated mold 12 is used to perform a shaping process on the base material 10 to transfer a pattern form the mold 12 to the base material 10. The shaping process may be a hot embossing process, an injection molding process, a rolling imprint process, or another conventional shaping process. As shown in FIG. 3, the mold 12 is then removed to render the base material 10 into a structural layer 14, wherein the structural layer 14 includes an alignment layer 16 monolithically formed with a plurality of spacers 18. The height, width, and configuration of the spacers 18 may be different depending on the demand of the product, and the form of the spacers 18 may be cylindrical, tapered, prismatic, hemispheric or another shape. In addition, the method of forming the alignment layer and the spacers according to the present invention is not limited to the shaping process by the mold 12. In other words, the structural layer 14 may be formed by the shaping process without the mold 12 such as a laser engraving process, an etching process or another manufacture process. If the shaping process without the mold 12 is used, then the step in FIG. 2 is no longer required and the structural layer 14 in FIG. 3 is directly formed.

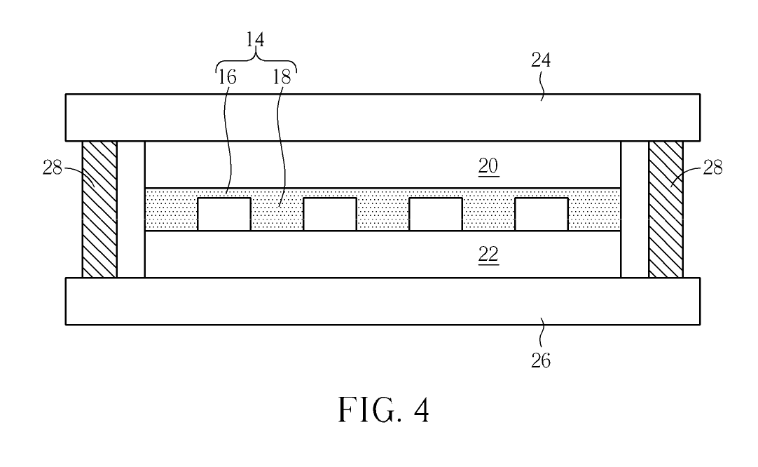

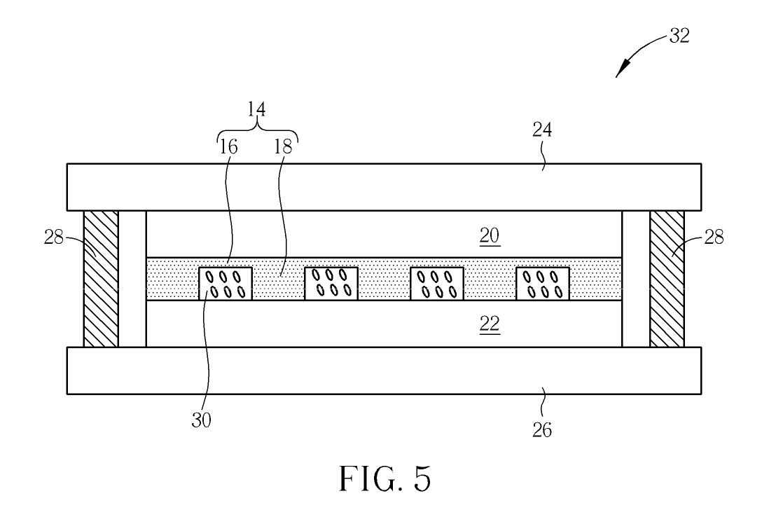

Please refer to FIGS. 4-5 and FIGS. 1-3. FIGS. 4-5 are schematic diagrams illustrating a method of forming a flexible display panel according to a preferred embodiment of the present invention. As shown in FIG. 4, a first transparent conductive film 20 and a second transparent conductive film 22 are provided, wherein the first transparent conductive film 20 may be mounted on a first flexible substrate 24 and the second transparent conductive film 22 may be mounted on a second flexible substrate 26. Then, the structural layer 14 is mounted on the first transparent conductive film 20 or the second transparent conductive film 22. Subsequently, a sealant 28 is used to bond the first flexible substrate 24 to the second flexible substrate, so that the first transparent conductive film 20, the structural layer 14 and the second transparent conductive film 22 form a sandwich structure. As shown in FIG. 5, a liquid crystal layer is formed between the first transparent conductive film 20 and the second transparent conductive film 22 to form a flexible display panel 32.

As a result, the present invention uses the shaping technique to directly form the alignment layer with a plurality of monolithically-formed spacers, and then the present invention uses the two-plate technique of the flexible circuit board to form the flexible display panel. The steps of forming the flexible display panel and the alignment layer and the spacers are explained as follows, and please refer to FIGS. 1-5.

A forming process of the base material, comprising:

A Premixing Step:

A major material, such as thermoplastic polyurethane (TPU), is premixed with a polyblend, such as at least one of silica, glass powder, or carbon fiber, and the polyblend is preferably a nanometer-scale material. In this invention, the major material is not limited to the thermoplastic polyurethane, and the polyblend is not limited to the silica, the glass powder, or the carbon fiber. In addition, the weight ratio of the polyblend to the major material may be adjusted, such as 5/95, 10/90, or 15/85, depending on the material it used, but it is not limited herein.

A Mixing Step:

The major material and the polyblend after the premixing step are added and mixed in a Brabender mixer. In this embodiment, an operating temperature of the Brabender mixer is 180° C., a rotation speed is 20 rpm, and a mixing time is 10 min, but it is not limited herein.

A Step of Forming the Base Material:

The material after the mixing step is used to form a sheet. In this embodiment, the sheet is formed by the hot embossing process and an operating temperature is 200° C., but it is not limited herein.

A test of mechanical and optical properties, comprising:

A Wear Testing Step:

The wear testing step is performed on a sample of the sheet to make sure if the abrasion resistance of the sheet conforms to the product specification. If it conforms to the product specification, then the following steps can be performed; if it doses not conform to the product specification, the materials and percentages of the major material and the polyblend or the operating parameters would be adjusted.

A Hardness Testing Step:

The hardness testing step is performed on a sample of the sheet to make sure if the hardness of the sheet conforms to the product specification. If it conforms to the product specification, then the following steps can be performed; if it doses not conform to the product specification, the materials and percentages of the major material and the polyblend or the operating parameters would be adjusted.

A Light Transmission Testing Step:

The light transmission testing step is performed on a sample of the sheet to make sure if the light transmission of the sheet conforms to the product specification. If it conforms to the product specification, then the following steps can be performed; if it doses not conform to the product specification, the materials and percentages of the major material and the polyblend or the operating parameters would be adjusted.

The shaping process, comprising:

A Hot Embossing Step:

After the sample of the sheet passes the aforementioned testing steps, a prefabricated mold, such as a mold formed by a laser engraving process, is used to perform the hot embossing step on the sheet, so that the pattern of the mold are transferred to the sheet to form a structural layer including an alignment layer monolithically formed with a plurality of spacers. In this embodiment, an operating temperature is 200° C., and an operating pressure is between 20 Kg/cm² and 80 Kg/cm², but it is not limited herein. In addition, the structural layer is formed by the hot embossing process, but it is not limited herein and may be another kind of the shaping process.

The Mounting of the Structural Layer and the Transparent Conductive Film:

The structural layer is cut in an appropriate scale and the structural layer is mounted to a first transparent conductive film. In this embodiment, the first transparent conductive film may be indium tin oxide (ITO) and may be formed on a polyethylene terephthalate (PET) thin film in advance, but it is not limited herein. Then, the first transparent conductive film is mounted to a surface of a first flexible substrate. Subsequently, the first transparent conductive film in a sealant region is removed. In this embodiment, the first transparent conductive film outside the sealant region is protected by a protecting tape, and an argon plasma process is performed to etch the first transparent conductive film in the sealant region, wherein an operating power of the argon plasma process is 40 W, an operating pressure is 250 mtorr, and a processing time is 3 min. But it is not limited herein. In addition, a second transparent conductive film is mounted on a surface of a second flexible substrate. Following that, a sealant is used to bond the first flexible substrate to the second flexible substrate. In this embodiment, the sealant is an ultraviolet hardening sealant, and the sealant is irradiated by ultraviolet light with a power of 400 W lasting for 50 seconds to harden the sealant such that the first flexible substrate is bonded to the second flexible substrate. But the type of the sealant is not limited to the ultraviolet hardening sealant.

A Step of Liquid Crystal Injection:

Subsequently, liquid crystal is injected between the first transparent conductive film and the second transparent conductive film to form a liquid crystal layer. In this embodiment, the liquid crystal is TN type and is doped with a dye in a percentage of 2%, but it is not limited herein.

A Step of Photoelectric Effect Testing:

The step of photoelectric effect testing is performed on the flexible display panel to make sure that if flexible display panel is in the normal operation.

In conclusion, the present invention uses all kinds of shaping techniques to directly form the alignment layer with a plurality of monolithically-formed spacers, so that the manufacture process is simple and it can improve the degree of hardness and the abrasion resistance of the spacers. In addition, the present invention uses the two-plate technique of the flexible circuit board to form the flexible display panel, so that the manufacture processes is simple and it can improve the durability and the flexibility of the flexible display panel.

Those skilled in the art will readily observe that numerous modifications and alterations of the device and method may be made while retaining the teachings of the invention.

What is claimed is:

1. A method of forming an alignment layer and spacers, comprising:
providing a base material; and
performing a shaping process on the base material to render a structural layer, wherein the structural layer comprises an alignment layer monolithically formed with a plurality of spacers.

2. The method of claim 1, further comprising using a mold to perform the shaping process.

3. The method of claim 1, wherein the base material comprises a plastic material.

4. The method of claim 3, wherein the plastic material comprises a thermoplastic material.

5. The method of claim 3, wherein the plastic material comprises a thermosetting material.

6. A method of forming a flexible display panel, comprising:
providing a base material;
performing a shaping process on the base material to render a structural layer, wherein the structural layer comprises an alignment layer monolithically formed with a plurality of spacers; and
providing a first transparent conductive film and a second transparent conductive film, and mounting the structural layer between the first transparent conductive film and the second transparent conductive film, wherein the first transparent conductive film, the structural layer and the second transparent conductive film form a sandwich structure.

7. The method of claim 6, further comprising mounting the first transparent conductive film on a first flexible substrate and mounting the second transparent conductive film on a second flexible substrate.

8. The method of claim 7, further comprising using a sealant to bond the first flexible substrate to the second flexible substrate.

9. The method of claim 8, further comprising forming a liquid crystal layer between the first transparent conductive film and the second transparent conductive film.

10. The method of claim 6, further comprising using a mold to perform the shaping process.

11. The method of claim 6, wherein the base material comprises a plastic material.

12. The method of claim 11, wherein the plastic material comprises a thermoplastic material.

13. The method of claim 11, wherein the plastic material comprises a thermosetting material.
